(19) United States
(12) Patent Application Publication
(10) Pub. No.: US 2023/0055336 A1
(43) Pub. Date: Feb. 23, 2023

(54) ATTACHMENT FOR GUIDING AN ANIMAL INTO A TRAP

(71) Applicant: Mina Youssef, South Plainfield, NJ (US)

(72) Inventor: Mina Youssef, South Plainfield, NJ (US)

(21) Appl. No.: 17/649,144

(22) Filed: Jan. 27, 2022

Related U.S. Application Data
(60) Provisional application No. 63/260,365, filed on Aug. 18, 2021.

(51) Int. Cl. A01M 23/16

(52) U.S. Cl. CPC A01M 23/16

(57) ABSTRACT

The present invention generally relates to improvements in live animal traps. In particular, the present invention relates to a device and mechanisms for incorporating a means to guide an animal into a live animal trap. In some embodiments thereof, the invention may comprise an attachment separate or built-in to a live animal trap to lead animals, generally groundhogs, into the trap as they exit a ground hole or any such habitat. Said attachment additionally serves as a means to prevent other animals from getting trapped. In a non-limiting application, the disclosure describes a device that allows people to trap a specific animal causing damage to their yard without trapping home pets or other animals.

### CROSS-REFERENCE TO RELATED APPLICATIONS

This application claims the priority benefit of the provisional application No. 63/260,365 filed on 2021 Aug. 18.

The above-named provisional patent application is incorporated herein by reference in its entirety.

### FIELD OF INVENTION

The present invention generally relates to improvements in animal traps. In particular, the present invention relates to a device and mechanisms for incorporating a means to guide an animal into a live animal trap.

### BACKGROUND OF THE INVENTION

Groundhogs and other small animals are a major issue for homeowners and can ruin a yard by digging tunnels throughout the yard. Other small animals can also damage property or are generally a nuisance. While there are numerous animal traps available to trap groundhogs and other animals, animals outsmart them by simply avoiding them. Normal traps may also catch cats, pets or small dogs causing other issues for trap users.

Numerous inventions describe traps used to capture animals. For example, the U.S. Pat. No. 982,001A described improvements in animal traps and more particularly to means for forcing the animal into a trap body or cage when the animal actuates a bait holder. The object of the disclosure is to provide a simple and practical device which may be used in connection with various kind of cages, which will be automatic in operation and self-setting so that after one animal has been forced into the cage the parts will be reset, and which will be simple in construction, strong and durable and comparatively inexpensive.

In another example, U.S. Pat. No. 6,684,560B2 described an animal trap for capturing small animals, such as rodents, and birds and a method for using the trap. The trap includes a chamber having side walls, an entrance, and a perforated end wall opposite the entrance; a first platform adjacent the entrance pivotally mounted to the side walls, the first platform providing a path from the entrance; a second platform located away from the entrance pivotally mounted to the side walls and having a first end extending beneath the first platform; and means for holding the first and second platforms in an essentially horizontal position; wherein when an animal passes through the entrance and contacts the second platform, the second platform pivotally deflects and pivotally deflects the second platform wherein the first platform obstructs the entrance and the animal is captured.

U.S. Ser. No. 11/154,046B2 describes a snap style vermin trap disposed on a planar platform having a concave bait box with a vertical trigger. The bait box is centrally located on the front face of the trigger and positioned at a distance above the top face of the platform so as orientate the vermin into a physical posture that greatly enhances the probability of a kill or capture. The trap may be oriented with the platform beneath or above the rapid actuation means of the snap trap and it may use an optional housing to cover the rapid actuation means.

Even further improvements to these small animal traps can be seen as disclosed in U.S. Pat. No. 9,439,412B2, where it is described a non-lethal animal trap that comprises a housing, a mechanically actuated trap door, a motion sensor, and a microprocessor controlled tripping mechanism. The trap includes a pathway having a first and second entrance and a first and second trap door. The pathway includes animal bait therein, where above a motion sensor detects objects and motion within the pathway such that the entrances to the pathway are closed by the trap doors. The motion sensor sends signals to the microprocessor, which in turn activates an electrical latch mechanism that releases the trap door mechanism from its set position to its closed position. Once closed, each trap door includes a brace that prevents the animal from forcibly opening the door. The animal is then trapped for later disposal or relocation.

Other documents useful in understanding the art include U.S. Pat. No. 5,265,371A, US20050178047A1 and numerous other patent documents published in the art of animal trapping.

All the traps described in the prior art do not lead groundhogs and other small animals into the trap, or deter them from avoiding the trap. Prior art devices may also catch unwanted animals such as cats, small dogs, skunks, raccoon, and possums. This can create a nuisance for users as they are forced to deal with animals that they did not intent to catch.

It is thus an object of this disclosure to provide a means to allow trapping a specific animal causing damage to their yard or property without trapping home pets or other animals.

### SUMMARY OF THE INVENTION

The following summary is an explanation of some of the general inventive steps for the device, system, methods, and tools in the description. This summary is not an extensive overview of the invention and does not intend to limit the scope beyond what is described and claimed as a summary.

The present invention generally relates to improvements in live animal traps. In particular, the present invention relates to a device and mechanisms for incorporating a means to guide an animal into a live animal trap.

In some embodiments thereof, the invention may comprise an attachment separate or built-in to a live animal trap to lead animals, generally groundhogs, into the trap as they exit a ground hole or any such habitat. Said attachment additionally serves as a means to prevent other animals from getting trapped.

In a non-limiting application, the disclosure describes a device that allows people to trap a specific animal causing damage to their yard without trapping home pets or other animals.

According to one embodiment, an attachment which surrounds the hole/habitat made by the groundhog/small animal is provided to a live animal trap such as those described in the prior art. It leads the animal into the trap as they have nowhere else to go except back into the hole/habitat or into the trap.

According to one embodiment, a trap comprising the attachment prevents the animal such as a groundhog from avoiding the trap. It leads the animal into the trap to be transported to a safe place.

According to one embodiment, the disclosed device and system allow users to trap a specific animal causing damage to their yard without trapping house pets or other animals.

For a more complete understanding of the above listed features and advantages of the guide for animal into a live animal trap, reference should be made to the detailed description and the drawings. Further, additional features and advantages of the invention are described in, and will be apparent from, the detailed description of the preferred embodiments.

### BRIEF DESCRIPTION OF THE DRAWINGS

The novel features believed to be characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 of the drawings illustrates a guide attachment for guiding an animal from its habitat to a trap entry in a disengaged position.

FIG. 2 of the drawings illustrates a guide attachment for guiding an animal from its habitat to a trap entry in an engaged position.

FIG. 3 of the drawings illustrates an animal trapped in a live animal trap after being guided into the trap from its habitat by the guide attachment.

FIG. 4 of the drawings is a prior art trap without the guide attachment.

FIG. 5 of the drawings is an exemplary illustration of the guide attachment according to one embodiment of the current invention.

FIG. 6 of the drawings illustrates a curved guide attachment for guiding an animal from its habitat to a trap entry in an engaged position.

FIG. 7 of the drawings illustrates a curved guide attachment for guiding an animal from its habitat to a trap entry in a disengaged position.

FIG. 8 of the drawings illustrates a guide attachment for guiding an animal from its habitat to a trap entry with a provision for animal entry on one of its lateral members.

### DETAILED DESCRIPTION OF THE PREFERRED EMBODIMENTS

Hereinafter, the preferred embodiment of the present invention will be described in detail with reference to the accompanying drawings. The terminologies or words used in the description and the claims of the present invention should not be interpreted as being limited merely to their common and dictionary meanings. On the contrary, they should be interpreted based on the meanings and concepts of the invention in keeping with the scope of the invention based on the principle that the inventor(s) can appropriately define the terms in order to describe the invention in the best way.

It is to be understood that the form of the invention shown and described herein is to be taken as a preferred embodiment of the present invention, so it does not express the technical spirit and scope of this invention. Accordingly, it should be understood that various changes and modifications may be made to the invention without departing from the spirit and scope thereof.

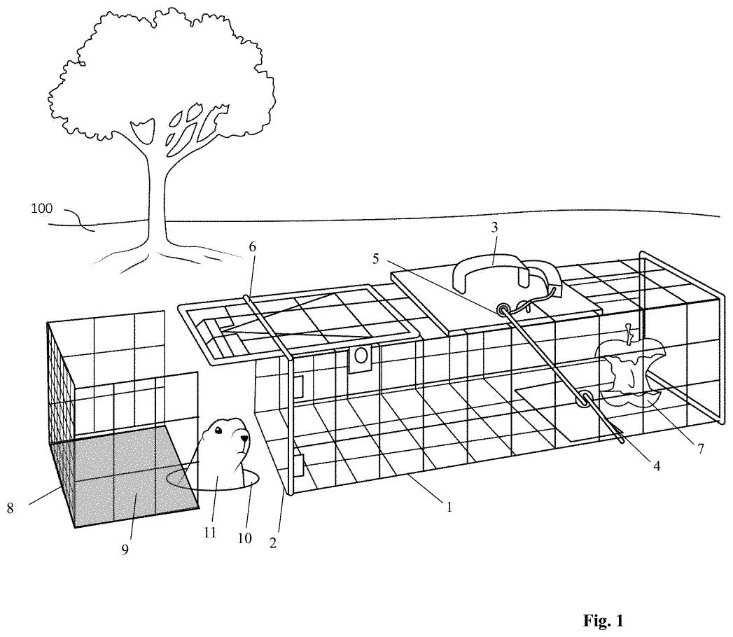

In a first embodiment according to the FIG. 1 of the drawings, it is illustrated a guide attachment 8 for guiding an animal from its habitat into a trap entry in a disengaged position. The guide attachment and animal trap may be combined into a system for guiding an animal from its habitat and/or hiding place into a trap. On the illustration, it is shown an animal trap 1, the trap having an animal trap entry 2 for letting an animal into the trap which is capable of holding a trapped animal into a chamber defined in the trap. The trap in the illustration is shown to have a trap handle 3, which is a feature for easy handling and/or carriage of the trap for storage or during setup to capture an animal. A trap actuator 4 is shown inside the trap chamber, the trap actuator 4 being engaged with a trap entry door actuator 5 coupled to the trap entry door 6. The trap entry door 6 may be activated to block the trap entry 2, and therefore, trapping an animal inside the trap chamber. Typically, an animal trap may include a bait 7 engaged to the trap actuator 4, the bait being provided to attract an animal into the trap and being set up such that trap actuator 4 becomes actuated by action of the animal eating into the bait or engaging it while trying to reach the bait. Subsequently, the actuation of the trap actuator 4 causes the engagement of the with a trap entry door actuator 5 to close the trap entry door 6 thereby trapping the animal into the trap.

The guide attachment 8 is shown to define a guide area 9 which may be set up to fall around the animal habitat/hiding 10 when engaged to the trap such that an animal 11 can only move back into its habitat or into the trap.

The particular trap illustrated in the examples is one capable of holding the animal in the trap body or cage when the animal actuates a bait holder. However, other types of traps may be used in combination with the guide attachment, and are thus anticipated herewith.

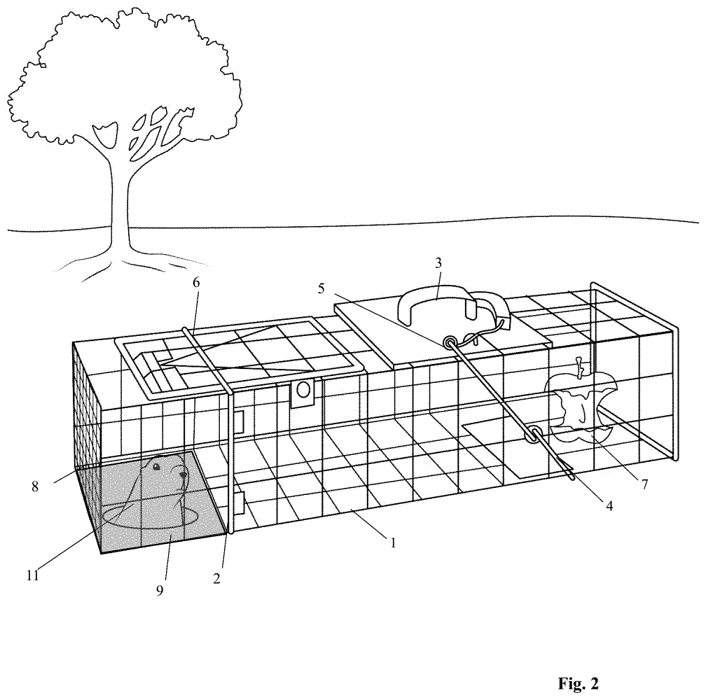

The illustrative embodiment according to FIG. 2 of the drawings illustrates a guide attachment 8 for guiding an animal from its habitat into a trap entry 2 in an engaged position. The guide attachment 8 is shown to define a guide area 9 (which may be set up to fall around the animal habitat/hiding 10 as in FIG. 1) between itself and the trap entry when engaged to the trap 1 such that an animal 11 can only move back into its habitat or into the trap. The engaged guide attachment and trap comprise a system for guiding an animal from its habitat and/or hiding place into a trap.

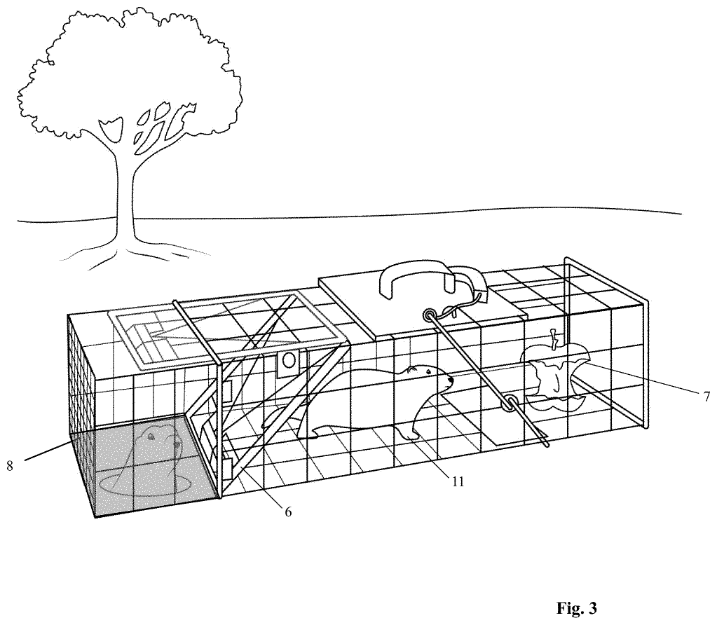

In a subsequent embodiment according to the FIG. 3 of the drawings, it is illustrated an animal trapped in a live animal trap after being guided into the trap from its habitat by the guide attachment.

The system includes a bait 7 to lure the animal 11 into the trap, with the bait being engaged to the trap actuator 4, the bait being provided to attract an animal into the trap and being set up such that trap actuator 4 becomes actuated by action of the animal eating into the bait or engaging it while trying to reach the bait. Subsequently, the actuation of the trap actuator 4 causes the engagement of the with a trap entry door actuator 5 to close the trap entry door 6 thereby trapping the animal into the trap.

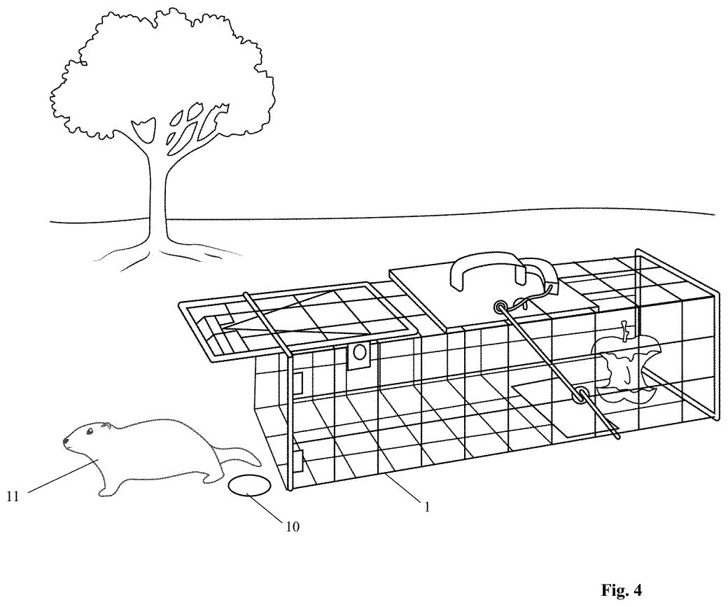

Illustrated as in FIG. 4 of the drawings is a prior art trap without the guide attachment. The animal 11 may emerge from its habitat/hiding place 10 and simply walk away from the trap 11. additionally, since the trap is open, any number of other animals may enter the trap and get trapped instead of the animal emerging from the habitat/hiding place 10.

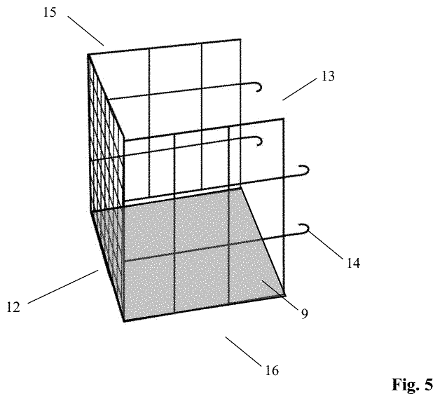

The non-limiting embodiment according to FIG. 5 of the drawings serves to provide a further exemplary illustration of the guide attachment 8. The guide attachment has a posterior 12, two lateral sides 15 and 16 and an anterior 13. The posterior 12, two lateral sides 15 and 16 enclose a guide area 9, which may be set up to fall around the animal habitat/hiding 10 as in FIG. 1. The anterior is at least partially open, the open end being able to engage to a trap entry. There may be provided an engagement means 14 to the guide attachment anterior, such as hooks, screws, magnets or the like, to enable the attachment to engage to an animal trap while in use.

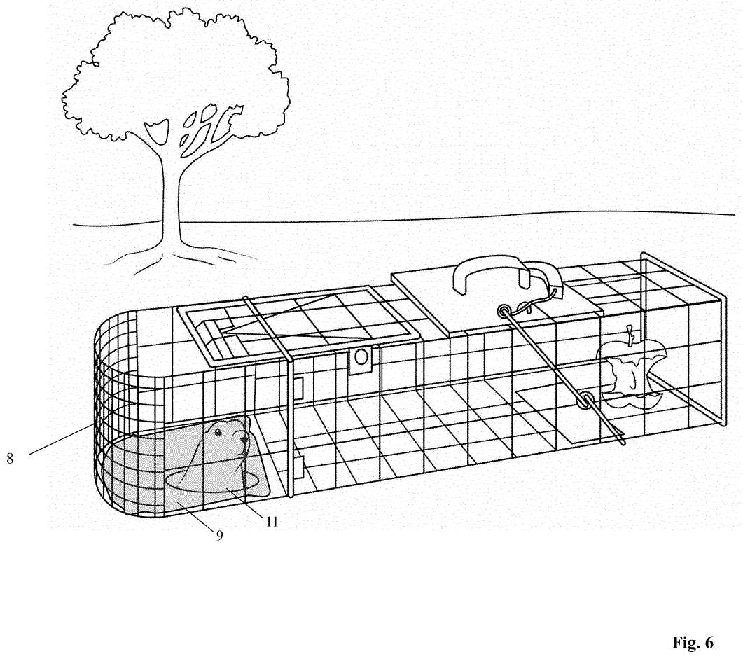

Referring to FIG. 6 of the drawings, it is illustrated a curved guide attachment 8 enclosing a guide area 9 for guiding an animal 11 from its habitat to a trap entry in an engaged position.

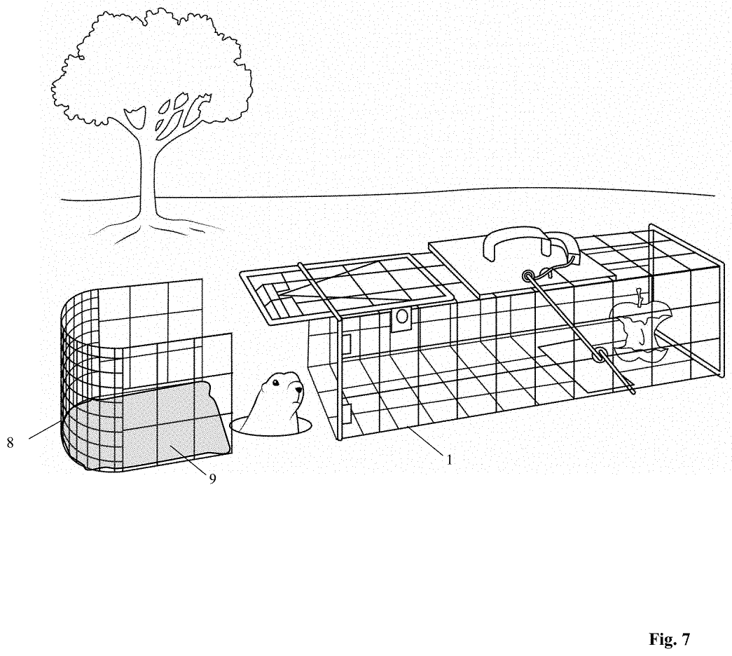

Referring to FIG. 7 of the drawings, it is illustrated a curved guide attachment 8 enclosing a guide area 9 for guiding an animal 11 from its habitat to a trap entry.

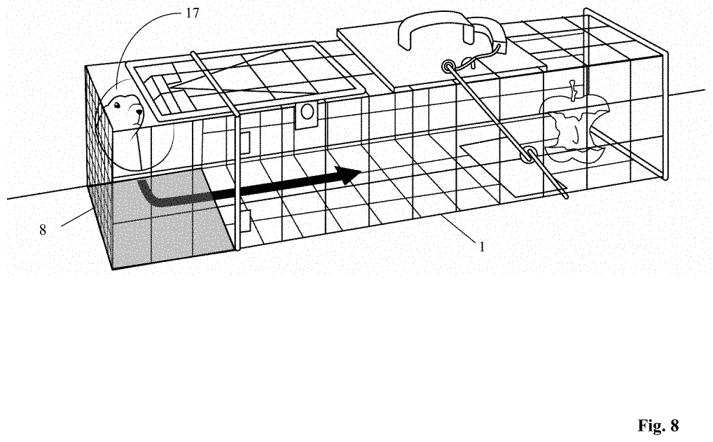

The last shown embodiment according to FIG. 8 of the drawings illustrates a guide attachment for guiding an animal from its habitat to a trap entry with a provision for animal entry 17 on one of its lateral members. In this example, the animal being trapped may have its habitat entering a wall, tree or fence at a position above the ground hence necessitating the placement of the animal entry 17 as such. The guide attachment enclosure defines a guide area preventing an animal in its habitat from avoiding the trap by only leading the animal to the trap entry or back to its habitat.

It is anticipated that the placement of animal entry 17 on the guide attachment may be adaptable.

It is further anticipated that the anterior of the guide attachment may have a variable seize opening to adapt to traps of different sized entries.

### How to Use the Invention

A person would use the trap with the guide attachment already built in or added to the trap and places on top of the animal made hole or habitat. As the animal exits the habitat/hole, it will be led into the trap.

Additionally, the attachment may be adjusted to let animals enter through the side. For example, by placing it adjacent to the wall. Two sides of the attachment can be used (as a L shape) to allow animals to enter through a hole and turn right or left into the trap. Most trap openings are not flat (with the trap entry sticking out more than the rest of the trap). This would allow a person to set the trap with no openings for the animal to escape.

The current invention is especially helpful in trapping ground hogs that tend to dig holes into a yard, causing a menacing nuisance.

Although a preferred embodiment of the present invention has been described for illustrative purposes, those skilled in the art will appreciate that various modifications, additions and substitutions are possible, without departing from the scope and spirit of the invention as disclosed in the accompanying claims. Such alterations are herewith anticipated.

Accordingly, the applicant intends to embrace all such alternatives, modifications, equivalents and variations that are within the spirit and scope of the disclosed subject matter. It should also be understood that references to items in the singular should be understood to include items in the plural, and vice versa, unless explicitly stated otherwise or clearly from the context. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

### INDUSTRIAL APPLICATION

The invention is applicable in the trap construction and pest eradication industry.

Further, the current invention relates to landscaping industry, and specifically in the elimination of destructive pests for more landscape beauty.

What is claimed is:

1. A system for guiding an animal from its habitat and/or hiding place into a trap, the system comprising of:
an animal trap defining a chamber for holding a trapped animal, the trap having an entry for an animal; and
a guide attachment defining an enclosure, the attachment being comprised of posterior and lateral sides, the enclosure having an anterior, the anterior being at least partially open to the trap entry, wherein:
the guide attachment enclosure defines a guide area between its posterior and anterior; and
the defined enclosure prevents an animal in its habitat from avoiding the trap by only leading the animal within the guide area, to the trap entry or back to its habitat.

2. The system according to claim 1, wherein the guide attachment enclosure prevents animals outside the enclosure from entering the guide area by means of said closed posterior and lateral sides.

3. The system according to claim 1, wherein said closed posterior and lateral sides of the guide attachment define a curved enclosure.

4. The system according to claim 1, wherein said closed posterior and lateral sides of the guide attachment define a box-like enclosure.

5. The system according to claim 1, wherein said defined enclosure comprises an entrance at either or all of its posterior and/or lateral sides, the entrance being open to an animal habitat.

6. The system according to claim 1, wherein the guide attachment comprises a means to engage the entry of the animal trap.

7. A guide attachment for guiding an animal from its habitat and/or hiding place into a trap, the guide comprising of
an engagement means to engage the entry of an animal trap; and
a enclosure defined by posterior and lateral sides of the guide attachment, the enclosure defining an anterior, the anterior being at least partially open to the trap entry, wherein:
the guide attachment enclosure defines a guide area between its posterior and anterior; and
the defined enclosure prevents an animal in its habitat from avoiding the trap by only leading the animal within the guide area, to the trap entry or back to its habitat.

8. The guide attachment according to claim 7, wherein the defined enclosure prevents animals outside the enclosure from entering the guide area by means of said closed posterior and lateral sides.

9. The guide attachment according to claim 7, wherein said closed posterior and lateral sides of the guide attachment define a curved enclosure.

10. The guide attachment according to claim 7, wherein said closed posterior and lateral sides of the guide attachment define a box-like enclosure.

11. The guide attachment according to claim 7, wherein said defined enclosure comprises an entrance at at least its posterior and/or lateral sides, the entrance being open to an animal habitat.

12. A method for guiding an animal from its habitat and/or hiding place into a trap, the method comprising of: providing
providing an animal trap defining a chamber for holding a trapped animal, the chamber having an entry for an animal; and
providing a guide attachment defining an enclosure comprised of a posterior and lateral sides, the enclosure defining an anterior, the anterior being at least partially open to the trap entry, wherein:
the provided guide attachment enclosure defines a guide area to an animal habitat therein between its posterior and anterior; and
the guide area preventing an animal in its habitat from avoiding the trap by only leading the animal to the trap entry or back to its habitat.

13. The method according to claim 12, wherein the guide attachment enclosure prevents animals outside the enclosure from entering the guide area by means of said closed posterior and lateral sides.

14. The method according to claim 12, wherein said closed posterior and lateral sides of the guide attachment define a curved enclosure.

15. The method according to claim 12, wherein said closed posterior and lateral sides of the guide attachment define a box-like enclosure.

16. The method according to claim 12, wherein said defined enclosure comprises an entrance at either or all of its posterior and/or lateral sides, the entrance being open to an animal habitat.

17. The method according to claim 12, wherein the guide attachment comprises a means to engage the entry of the animal trap.
